(19) United States
(12) Patent Application Publication
(10) Pub. No.: US 2011/0135095 A1
(43) Pub. Date: Jun. 9, 2011

(54) Method and system for generating key identity identifier when user equipment transfers

(75) Inventors: Xuwu Zhang, Shenzhen (CN); Lu Gan, Shenzhen (CN); Qing Huang, Shenzhen (CN)

(73) Assignee: ZTE CORPORATION, Shenzhen, Guangdong (CN)

(21) Appl. No.: 12/996,630

(22) PCT Filed: Dec. 29, 2008
(86) PCT No.: PCT/CN2008/002116

§ 371 Date: Dec. 7, 2010

(30) Foreign Application Priority Data
Jun. 16, 2008 (CN) 200810100472.9

(51) Int. Cl. H04W 12/04

(52) U.S. Cl. 380/272

(57) ABSTRACT

A method for generating a key identity identifier when a user equipment (UE) transfers is disclosed. The method includes the following steps: a mobility management entity (MME) of an evolved UMTS terrestrial radio access network (EUTRAN) sends an identity identifier of an access security management entity key (KSI_{ASME}) to a serving general packet radio service support node (SGSN) of a target system when the UE transfers from the EUTRAN to the target system, and both the SGSN and the UE map the KSI_{ASME} into a key identity identifier of the target system.

### TECHNICAL FIELD

The present invention relates to the field of mobile telecommunications, particularly to a method and system for generating a key identity identifier when a user equipment transfers.

### BACKGROUND

When a user equipment (UE) transfers among different access systems in a mobile telecommunications system, security parameters of a source service network are required to be mapped into those capable of being recognized and used by a target service network, so that the UE can transfer successfully and develop services. These security parameters include a key, a key identifier, a counter, a security algorithm, etc.

A 3GPP evolved packet system (EPS) consists of an evolved UMTS terrestrial radio access network (EUTRAN) and an evolved packet core (EPC) network.

Wherein the EPC network comprises a mobility management entity (MME), which is responsible for tasks related to a control surface, e.g., management of mobility, processing of non-access stratum signaling, and management of the user-side safe mode, etc.; wherein the MME stores a root key K_{ASME} (Access Security Management Entity Key) of the EUTRAN, and generates a root key K_{eNB} (eNB Key) of an access stratum for an evolved Node B (eNB) based on the K_{ASME} and an uplink non-access stratum sequence number (NAS SQN). A key set identifier for access security management entity (KSI_{ASME}) is an identity identifier (or key sequence number) of the K_{ASME}, and the KSI_{ASME} is 3-bits long and is used for identification and retrieval of a key between a network and a user equipment (UE). When connecting the UE with the network, according to the KSI_{ASME}, an opposite party may be notified to use a specified key which has been stored to establish security context without need of authentication and key association (AKA), network resources thus can be saved. When the key needs to be deleted due to termination of its lifetime or other causes, the KSI_{ASME} is set to “111” by the UE.

Wherein a base station device in the EUTRAN is an evolved Node B (eNB), and is mainly responsible for radio communications, radio communication management and mobility context management.

In a 3GPP universal mobile telecommunications system (UMTS), a serving GPRS support node (SGSN) is a device responsible for management of mobility context in the packet domain and/or management of the user-side safe mode. The SGSN is also responsible for the authentication and security management of a universal terrestrial radio access network (UTRAN) in the UMTS, and for storing an integrity key (IK) and a ciphering key (CK). A key identity identifier of the CK/IK is a key set identifier (KSI) whose function and use are similar to those of the KSI_{ASME} in the EPS, both of which are used for identification and retrieval of keys between a UE and a network, and the KSI is 3-bits long. When the KSI equals 111, it means that there is no usable key and the KSI is invalid. When it is necessary for the UE and the SGSN to establish a UMTS security connection through key association, if a usable key has been stored in the UE, then the UE sends the stored KSI to the SGSN which verifies whether the stored KSI is identical with the KSI stored in the UE, if yes, then the stored key set is used to establish security context through key association and the KSI is sent back to the UE to confirm the key that the UE uses; if no usable key is stored in the UE, then the KSI is set to 111 and is sent to the SGSN, and the SGSN, after detecting the KSI to be 111, sends an authentication request message to a home location register (HLR)/home subscriber server (HSS), and the UE and the network perform AKA for a second time and generate a new key set.

The SGSN is also a device responsible for management of mobility context in the packet domain and/or management of the user-side safe mode in a general packet radio service (GPRS)/enhanced data rates for GSM evolution (EDGE) system. The SGSN is responsible for the authentication and security management of a GPRS/EDGE radio access network (GERAN), and for storing a ciphering key (Kc) of the GERAN; an identity identifier (or key identity identifier) of the Kc is a ciphering key sequence number (CKSN) whose function and use are the same as those of the KSI.

When a UE transfers from an EUTRAN to a UTRAN, an MME generates a CK and an IK for a target service network based on a K_{ASME}, and sends the CK and the IK to an SGSN, then the UE and the SGSN use the CK and the IK to establish UTRAN security context by negotiating corresponding security algorithms; there are two types of transferring, including transferring when RRC (radio resource control) is in an active state and transferring when the UE is in an idle state, wherein the former includes switching, etc., and the latter includes route area update request, route area attachment request, etc.

When the UE transfers to a GERAN from the EUTRAN, the MME generates a CK and an IK based on the K_{ASME} (the method of which is the same as that of transferring to the UMTS), and sends the CK and the IK to an SGSN. The SGSN generates a Kc of the GERAN based on the IK and the CK.

In the prior art, a KSI_{ASME}, a KSI and a CKSN are all generated by a network side during authentication, and are sent to a UE through an authentication request message. In a process of transferring from an EUTRAN to a UTRAN or a GERAN, although an MME generates an IK and a CK needed by the UTRAN or the GERAN for a target service network, no identity identifier corresponding to the pair of keys is generated, after transfer termination the UE and the SGSN are not capable of retrieving the keys generated during transferring, and therefore, the pair of keys cannot be used. When the UE and the network need to re-establish radio resource control (RRC) or other connections, new keys have to be generated through AKA before establishing a radio connection, because those stored keys cannot be used. This undoubtedly increases the signaling overhead of both the network and the UE and delays the time of normal communication between the UE and the network, resulting in deterioration of user satisfaction.

### SUMMARY

The present invention mainly aims to provide a method and system for generating a key identity identifier when a user equipment transfers, which is capable of solving the problem in the prior art that a key mapped from a K_{ASME} in a transfer process has no identity identifier after a user equipment transfers from an EUTRAN to a UTRAN or a GERAN.

In order to solve the above-mentioned problem, the invention provides a method for generating a key identity identifier when a user equipment transfers, which includes the following steps:

when a UE transfers from an EUTRAN to a target system, an MME of the EUTRAN sends an identity identifier of a K_{ASME} (KSI_{ASME}) to an SGSN of the target system, and both the SGSN and the UE map the KSI_{ASME} into a key identity identifier of the target system.

Further, the mapping method may include the following steps: directly assigning the KSI_{ASME} to the key identity identifier of the target system, or directly assigning the sum of the KSI_{ASME} and a constant that is agreed on by the UE and the network to the key identity identifier of the target system.

Further, when the UE transfers in an idle state from the EUTRAN to a UTRAN, the specific steps may be as follows:

A1: after receiving a context request message or an identification request message, the MME generates an IK and a CK based on the K_{ASME}, and sends the KSI_{ASME} together with the IK and the CK which are generated from the K_{ASME} to the SGSN through a context response message or an identification response message;

A2: after receiving the KSI_{ASME}, the IK and the CK from the MME, the SGSN maps the KSI_{ASME} into a KSI, and stores the KSI, the IK and the CK together; and the SGSN sends a message of indicating mapping completion of the KSI to the UE; and

A3: the UE maps the KSI_{ASME} into a KSI, and stores the KSI together with the IK and the CK which are generated from the K_{ASME}.

Further, step A3 may take place in any step after the UE decides to transfer to the UTRAN in an idle state and before the UE sends a corresponding route area update completion message or attachment completion message to the SGSN.

Further, when the UE switches from the EUTRAN to the UTRAN, the specific steps may be as follows:

a1: after receiving a switching request message, the MME generates an IK and a CK based on the K_{ASME}, and sends the KSI_{ASME} together with the IK and the CK which are generated from the K_{ASME} to the SGSN through a forward and redirect request message;

a2: after receiving the KSI_{ASME} together with the IK and the CK from the MME, the SGSN maps the KSI_{ASME} into a KSI, and stores the KSI, the IK and the CK together; the SGSN sends a forward and redirect response message of indicating mapping completion of the KSI to the MME; and the MME sends a switching command to instruct the UE to switch; and

a3: after receiving the switching command from the network, the UE maps the KSI_{ASME} into a KSI, and stores the KSI together with the IK and the CK which are generated from the K_{ASME}.

Further, when the UE transfers in an idle state from the EUTRAN to a GERAN, the specific steps may be as follows:

B1: after receiving a context request or an identification request message, the MME generates an IK and a CK based on the K_{ASME}, and sends the KSI_{ASME} together with the IK and the CK which are generated from the K_{ASME} to the SGSN through a context response message or an identification response message;

B2: after receiving the KSI_{ASME}, the IK and the CK from the MME, the SGSN generates a Kc of the GERAN based on the IK and the CK, maps the KSI_{ASME} into a CKSN of the GERAN, and stores the CKSN of the GERAN together with the Kc of the GERAN; and the SGSN sends the UE a message of indicating mapping completion of the CKSN of the GERAN; and

B3: the UE maps the KSI_{ASME} into a CKSN of the GERAN, and stores the CKSN of the GERAN together with the Kc of the GERAN generated from the K_{ASME}.

Further, step B3 may take place in any step after the UE decides to transfer to the GERAN in an idle state and before the UE sends a switching message to the network.

Further, when the UE switches from the EUTRAN to a CERAN, the specific steps may be as follows:

b1: after receiving a switching request message, the MME generates an IK and a CK based on the K_{ASME}, and sends the KSI_{ASME} together with the IK and the CK which are generated from the K_{ASME} to the SGSN through a forward and redirect request message;

b2: after receiving the KSI together with the IK and the CK from the MME, the SGSN generates a Kc of the GERAN based on the IK and the CK, assigns the KSI_{ASME} value to a CKSN of the GERAN, and stores the CKSN of the GERAN together with the Kc of the GERAN; the SGSN sends a message of indicating mapping completion of the CKSN of the GERAN to the MME; and the MME sends a switching command to instruct the UE to switch; and

b3: after receiving the switching command from the network, the UE maps the KSI_{ASME} into a CKSN of the GERAN, and stores the CKSN of the GERAN together with the Kc of the GERAN generated from the K_{ASME}.

Further, the invention also provides a system for generating a key identity identifier when a user equipment transfers, including a user equipment, an MME and an SGSN;

the MME is used for sending an identity identifier of a K_{ASME} (KSI_{ASME}) to the SGSN when the UE transfers from an EUTRAN to a target system; and

both the SGSN and the UE are used for mapping the KSI_{ASME} into a key identity identifier of the target system.

Further, the SGSN/UE may perform mapping in the following method: directly assigning the KSI_{ASME} to the key identity identifier of the target system, or directly assigning the sum of the KSI_{ASME} and a constant that is agreed on by the UE and the network to the key identity identifier of the target system.

Further, the UE and the SGSN may be also used for deleting a key stored before the UE transfers when the UE and the SGSN have agreed on a key before the UE transfers, and when a key identity identifier of a target system is the same as the key identity identifier of the target system mapped from the KSI_{ASME} during transferring.

Further, the UE may consist of a message interaction unit, a key identifier mapping unit and a key and key identifier storage unit;

the message interaction unit is used for receiving a message from a network side;

the key identifier mapping unit is used for mapping the KSI_{ASME} into a key identity identifier of a target system when the message interaction unit receives a switching command, a route area update acceptance message or a route area attachment acceptance message; and

the key and key identifier storage unit is used for storing a key of a target system and a key identity identifier of the target system together.

The MME may consist of a request message receiving unit and a security parameter processing unit;

the request message receiving unit is used for receiving transfer request messages from other network entities and instructing the security parameter processing unit to process these messages; and

the security parameter processing unit is used for generating a CK and an IK from the K_{ASME} and sending the KSI_{ASME} together with the IK and the CK which are generated from the K_{ASME} to the SGSN after receiving the instruction from the request message receiving unit.

The SGSN may consist of a security parameter processing unit, a message interaction unit, a key identifier mapping unit, and a key generating unit;

the security parameter receiving unit is used for receiving the keys and the KSI_{ASME} from the MME, sending the KSI_{ASME} to the key identifier mapping unit; acquiring the key of the target system based on the keys sent by the MME, and sending it to the key and key identifier storage unit;

the key identifier mapping unit is used for mapping the KSI_{ASME} into a key identity identifier of the target system after receiving the KSI_{ASME};

the key and key identifier storage unit is used for storing both the key of the target system sent by the security parameter receiving unit and the key identity identifier of the target system sent by the key identifier mapping unit, and notifying the message interaction unit of mapping completion after storing; and

the message interaction unit is used for sending a notification of mapping success of the network-side key identifier after receiving the message of mapping completion.

Further, the key identifier mapping units in the UE and the SGSN may map the KSI_{ASME} into a key identity identifier of the target system, i.e. when the target system is a UTRAN, the KSI_{ASME} is mapped into a KSI; and when the target system is a GERAN, the KSI_{ASME} is mapped into a CKSN of the GERAN; and

the security parameter receiving unit in the SGSN may acquire the key of the target system based on the keys sent by the MME and sends it to the key and key identifier storage unit, i.e. when the target system is a UTRAN, the keys sent by the MME are sent to the key and key identifier storage unit; and when the target system is a GERAN, the keys sent by the MME are used to generate a Kc of the GERAN which is sent to the key and key identifier storage unit.

Further, the key identifier mapping unit in the UE may be also used for mapping the KSI_{ASME} into the key identity identifier of the target system when the UE decides to transfer in an idle state.

Further, the message interaction unit in the UE may also be used for sending a route area update request message or a route area attachment request message to the SGSN when the UE decides to transfer in an idle state;

the message interaction unit in the SGSN may also be used for sending a corresponding context request message or identification request message to the MME after receiving the route area update request message or the route area attachment request message;

the request message receiving unit in the MME may send a first processing instruction to the security parameter processing unit if the transfer request message is a context request message or an identification request message, and may send a second processing instruction to the security parameter processing unit if the transfer request message is a switching request message; and

the security parameter processing unit in the MME may send the KSI_{ASME} together with the IK and the CK which are generated from the K_{ASME} to the SGSN through a context response message or an identification response message after receiving the first processing instruction, and may send the KSI_{ASME} together with the IK and the CK which are generated from the K_{ASME} to the SGSN through a forward and redirect request message after receiving the second processing instruction.

Further, the message interaction unit in the SGSN may send a notification of mapping success of the network-side key identifier, i.e.: if the message of sending the key and the key identifier by the MME is a context response message or an identification response message, then the message interaction unit sends a route area update acceptance message or a route area attachment acceptance message to the UE to indicate mapping success of the network-side key identifier; and if the message of sending the key and the key identifier by the MME is a forward and redirect request message, then the message interaction unit sends a forward and redirect response message to the MME to indicate mapping success of the network-side key identifier.

The technical scheme of the present invention can provide a key with an identity identifier in a transfer process, to reuse a key generated from a K_{ASME}, thereby solving the problem that the key generated from the K_{ASME} cannot be reused due to lack of an identity identifier when a UE transfers from an EUTRAN to another system, thus reducing interactive signaling between the UE and the network.

### BRIEF DESCRIPTION OF THE DRAWINGS

The drawings to be described here are used to facilitate further understanding and constitute part of this application. The implementation examples of the present invention and the description thereof are used for explanation of the present invention, and shall not be construed as improper limitation to the present invention. In the drawings,

FIG. 1 is a schematic diagram illustrating a method for generating a KSI when a UE transfers from an EUTRAN to a UTRAN in the present invention;

FIG. 2 is a schematic diagram illustrating a method for generating a KSI when a UE transfers from an EUTRAN to a GERAN in the present invention;

FIG. 3 is a flowchart of realizing signaling of Application Example One of the method in the present invention;

FIG. 4 is a flowchart of realizing signaling of Application Example Two of the method in the present invention;

FIG. 5 is a flowchart of realizing signaling of Application Example Three of the method in the present invention;

FIG. 6 is a flowchart of realizing signaling of Application Example Four of the method in the present invention;

FIG. 7 is a flowchart of realizing signaling of Application Example Five of the method in the present invention; and

FIG. 8 is a flowchart of realizing signaling of Application Example Six of the method in the present invention.

### DETAILED DESCRIPTION

The technical scheme of the invention will be further described in details based on the drawings and embodiments.

A method for generating a key identity identifier when a UE transfers in the present invention includes the following steps:

when a UE transfers from an EUTRAN to a target system, an MME sends an identity identifier of a K_{ASME} (KSI_{ASME}) to an SGSN, and both the SGSN and the UE map the KSI_{ASME} into a key identity identifier of the target system.

Wherein the mapping method may include the following steps: directly assigning the KSI_{ASME} to the key identity identifier of the target system, or directly assigning the sum of the KSI_{ASME} and a constant to the key identity identifier of the target system; and

the SGSN and the UE agree on the mapping method and the constant.

Wherein the mapping method also includes the following step: the UE and the SGSN store the key identity identifier of the target system acquired from mapping together with the key of the target system generated from the K_{ASME}.

Wherein the sum of the KSI_{ASME} and the constant can not be 111, otherwise, it may be altered according to the agreement between the UE and the SGSN, e.g. by replacing it with a next value 000 or another value.

Wherein if the UE and the SGSN have agreed on a key before transferring and the stored key identity identifier of the target system is the same as the key identity identifier of the target system mapped from the KSI_{ASME} during transferring, then the key stored before transferring is deleted.

Wherein transferring of the UE from the EUTRAN to another radio access system means transferring of the UE to a UTRAN system or a GERAN system; and there are two types of transferring: idle transferring and switching.

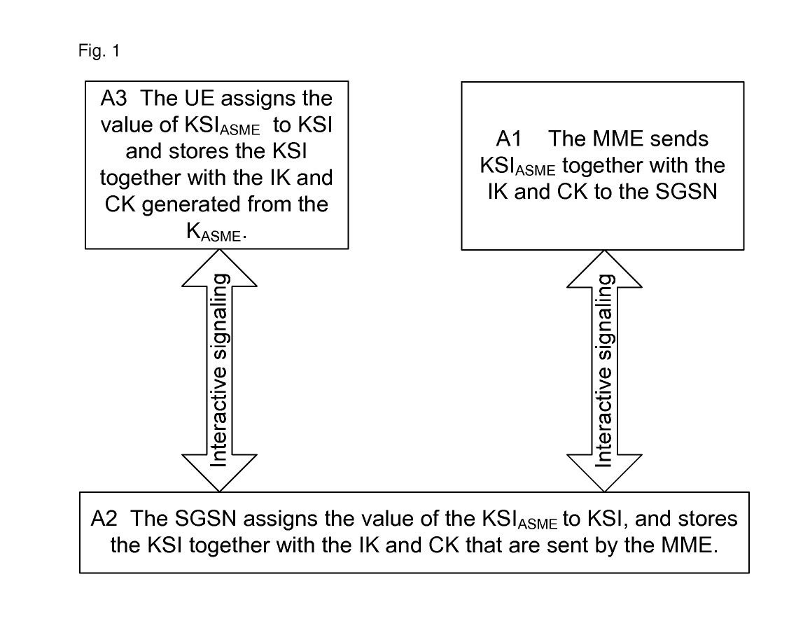

When the UE transfers in an idle state from the EUTRAN to a UTRAN, the generating method, as shown in FIG. 1, comprises the following specific steps:

A1: after receiving a context request message or an identification request message, an MME generates an IK and a CK based on the K_{ASME} and sends the KSI_{ASME} together with the IK and the CK which are generated from the K_{ASME} to the SGSN through a context response message or an identification response message;

A2: after receiving the KSI_{ASME}, the IK and the CK from the MME, the SGSN maps the KSI_{ASME} into a KSI, and stores the KSI, the IK and the CK together; and the SGSN sends a message of indicating mapping completion of the KSI to the UE; and

A3: the UE maps the KSI_{ASME} into a KSI, i.e., assigning the value of the KSI_{ASME} to the KSI: KSI=KSI_{ASME}, and stores the KSI together with the IK and the CK which are generated from the K_{ASME}.

Further, the following step is included before step A1:

A0: the UE decides to transfer to a UTRAN in an idle state, and sends the SGSN a request message of idle transferring to the UTRAN, wherein the request message is a route area update request message or a route area attachment request message; after receiving the request message of idle transferring to the UTRAN which is sent from the UE, the SGSN sends a corresponding request message to the MME.

Further, correspondingly, in step A2, the message of indicating mapping completion of the KSI sent by the SGSN is a route area update acceptance message or a route area attachment acceptance message.

Further, step A3 may take place in any step after the UE decides to transfer to the UTRAN in an idle state and before the UE sends a corresponding route area update completion message or route area attachment completion message to the SGSN.

When the UE switches from the EUTRAN to a UTRAN, the specific steps of the generating method are as follows:

a1: after receiving a switching request message, the MME generates an IK and a CK based on the K_{ASME}, and sends the KSI_{ASME} together with the IK and the CK which are generated from the K_{ASME} to the SGSN through a forward and redirect request message;

a2: after receiving the KSI_{ASME}, the IK and the CK from the MME, the SGSN maps the KSI_{ASME} into a KSI, and stores the KSI, the IK and the CK together; the SGSN sends a forward and redirect response message of indicating mapping completion of the KSI to the MME; and the MME sends a switching command to instruct the UE to switch; and

a3: after receiving the switching command from the network, the UE maps the KSI_{ASME} into a KSI, and stores the KSI together with the IK and the CK which are generated from the K_{ASME}.

The above-mentioned method for generating a KSI maps a value of a KSI_{ASME} in the EUTRAN into a value of a KSI in the UTRAN, and guarantees that the KSI acquired through mapping and a previously stored key sequence number do not repeat, thus solving the problem in the prior art that an IK and a CK acquired through mapping cannot be reused due to lack of identity identifiers when a UE transfers from an EUTRAN to a UTRAN.

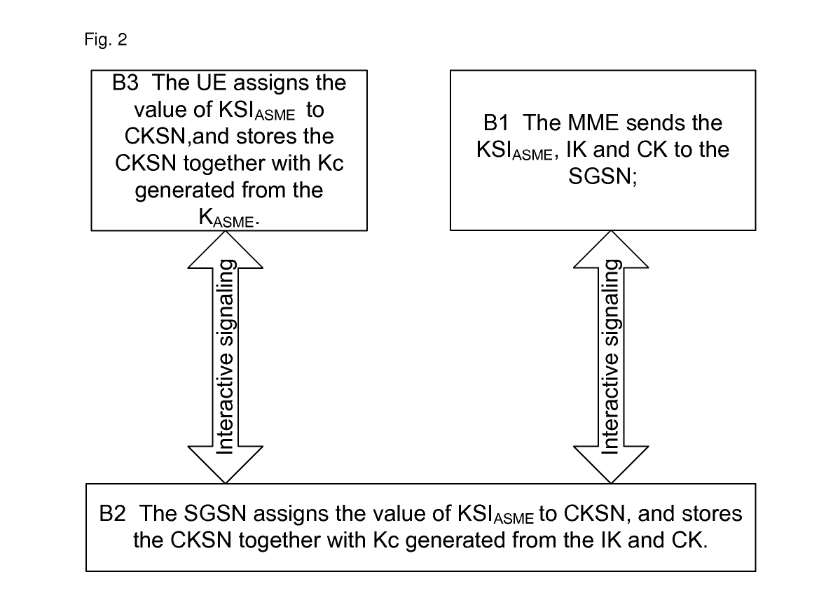

When the UE transfers in an idle state from the EUTRAN to a GERAN, the generating method, as shown in FIG. 2, comprising specific steps as follows:

B1: after receiving a context request or an identification request message, the MME generates an IK and a CK based on the K_{ASME}, and sends the KSI_{ASME} together with the IK and the CK which are generated from the K_{ASME} to the SGSN through a context response message or an identification response message;

B2: after receiving the KSI_{ASME}, the IK and the CK from the MME, the SGSN generates a Kc based on the IK and the CK, maps the KSI_{ASME} into a CKSN, and stores the CKSN together with the Kc generated from the IK and the CK; and the SGSN sends the UE a message of indicating mapping completion of the CKSN; and

B3: the UE maps the KSI_{ASME} into a CKSN, and stores the CKSN together with the Kc generated from the K_{ASME}.

Further, the following step is included before step B1:

B0: the UE decides to transfer to a GERAN in an idle state, and sends the SGSN a request message of idle transferring to the UTRAN, wherein the request message is a route area update request message or a route area attachment request message; after receiving the request message of idle transferring to the UTRAN which is sent from the UE, the SGSN sends a corresponding request message to the MME.

Correspondingly, in step B2, the message of indicating mapping completion of the CKSN sent by the SGSN is a route area update acceptance message or a route area attachment acceptance message.

Further, step B3 may take place in any step after the UE decides to transfer to the GERAN in an idle state and before the UE sends a corresponding switching message to a network side.

When the UE switches from the EUTRAN to a CERAN, the specific steps of the generating method are as follows:

b1: after receiving a switching request message, the MME generates an IK and a CK based on the K_{ASME}, and sends the KSI_{ASME} together with the IK and the CK which are generated from the K_{ASME} to the SGSN through a forward and redirect request message;

b2: after receiving the KSI, the IK and the CK from the MME, the SGSN generates a Kc based on the IK and CK, maps the KSI_{ASME} into a CKSN, and stores the CKSN together with the Kc generated from the IK and the CK; the SGSN sends a message of indicating mapping completion of the CKSN to the MME; and the MME sends a switching command to instruct the UE to switch; and

b3: after receiving the switching command from the network, the UE maps the KSI_{ASME} into a CKSN, and stores the CKSN together with the Kc generated from the K_{ASME}.

The above-mentioned generating method for a KSI maps a value of a KSI_{ASME} into a value of a CKSN, and guarantees that the CKSN and a previously stored key sequence number do not repeat, thus solving the problem in the prior art that a Kc acquired through mapping cannot be reused due to lack of identity identifiers when a UE transfers from an EUTRAN to a GERAN.

A system for generating a key identity identifier when a UE transfers in the present invention includes a UE, an MME and an SGSN;

the MME is used for sending a KSI_{ASME} to the SGSN when the UE transfers from an EUTRAN to a target system; and

both the SGSN and the UE are used for mapping the KSI_{ASME} into a key identity identifier of the target system;

wherein the SGSN/UE may perform mapping in the following method: directly assigning the KSI_{ASME} to the key identity identifier of the target system, or directly assigning the sum of the KSI_{ASME} and a constant to the key identity identifier of the target system;

the SGSN and the UE agree on the mapping method and the constant.

Wherein the SGSN and the UE are also used for storing the key identity identifier of the target system generated during mapping together with the target system key generated from the K_{ASME}.

Wherein the sum of the KSI_{ASME} and the constant can not be 111, otherwise, it may be altered according to the agreement between the UE and the SGSN, e.g. by replacing it with a next value 000 or another value.

The UE and the SGSN are also used for deleting a key stored before transferring when the UE and the SGSN have agreed on a key before transferring and the stored key identity identifier of the target system is the same as the key identity identifier of the target system mapped from the KSI_{ASME} during transferring.

Wherein transferring of the UE from the EUTRAN to another radio access system means transferring of the UE to a UTRAN system or a GERAN system; and there are two types of transferring: idle transferring and switching.

Wherein the UE consists of a message interaction unit, a key identifier mapping unit and a key and key identifier storage unit;

the message interaction unit is used for receiving a message from a network side;

the key identifier mapping unit is used for mapping the KSI_{ASME} into the key identity identifier of the target system when the message interaction unit receives a switching command, a route area update acceptance message or a route area attachment acceptance message, mapping the KSI_{ASME} into a KSI when the target system is a UTRAN, and mapping the KSI_{ASME} into a CKSN when the target system is a GERAN; and

the key and key identifier storage unit is used for storing a key of a target system and a key identity identifier of the target system together.

The MME consists of a request message receiving unit and a security parameter processing unit;

the request message receiving unit is used for receiving transfer request messages from other network entities and instructing the security parameter processing unit to process these messages; if the transfer request message is a context request message or an identification request message, then the request message receiving unit sends a first processing instruction to the security parameter processing unit; if the transfer request message is a switching request message, then the request message receiving unit sends a second processing instruction to the security parameter processing unit; and

the security parameter processing unit is used for generating a CK and an IK based on the K_{ASME} and sending the KSI_{ASME} together with the IK and the CK which are generated from the K_{ASME} to the SGSN after receiving an instruction from the request message receiving unit; if the instruction is the first processing instruction, then the security parameter processing unit sends the KSI_{ASME} together with the IK and the CK which are generated from the K_{ASME} to the SGSN through a context response message or an identification response message; and if the instruction is the second processing instruction, then the security parameter processing unit sends the KSI_{ASME} together with the IK and the CK which are generated from the K_{ASME} to the SGSN through a forward and redirect request message.

The SGSN consists of a security parameter processing unit, a message interaction unit, a key identifier mapping unit, and a key generating unit;

the security parameter receiving unit is used for receiving the keys and the KSI_{ASME} from the MME, sending the KSI_{ASME} to the key identifier mapping unit, generating a key of a target system based on the keys sent by the MME and sending it to the key and key identifier storage unit: if the target system is judged to be a UTRAN, then the security parameter receiving unit sends the keys sent by the MME to the key and key identifier storage unit; and if the target system is a GERAN, then the security parameter receiving unit generates a Kc based on the keys sent by the MME and sends the Kc to the key and key identifier storage unit;

the key identifier mapping unit is used for mapping the KSI_{ASME} into a key identity identifier of a target system after receiving the KSI_{ASME}: if the target system is judged to be a UTRAN, then the key identifier mapping unit maps the KSI_{ASME} into a KSI; and if the target system is a GERAN, then the key identifier mapping unit maps the KSI_{ASME} into a CKSN; and sending the key identity identifier acquired through mapping to the key and key identifier storage unit;

the key and key identifier storage unit is used for storing both the key of the target system sent by the security parameter receiving unit and the key identity identifier of the target system sent by the key identifier mapping unit, and notifying the message interaction unit of the mapping completion after storing; and

the message interaction unit is used for sending a notification of mapping success of the network-side key identifier after receiving the message of mapping completion.

Wherein the message interaction unit in the UE is also used for sending a route area update request message or a route area attachment request message to the SGSN when the UE decides to transfer in an idle state; and

the message interaction unit in the SGSN is also used for sending a corresponding context request message or identification request message to the MME after receiving the route area update request message or the route area attachment request message.

Wherein the key identifier mapping unit in the UE is also used for mapping the KSI_{ASME} into the key identity identifier of the target system when the UE decides to transfer in an idle state.

Wherein the message interaction unit in the SGSN sends a notification of mapping success of the network-side key identifier, i.e.: if the message of sending the key and the key identifier by the MME is a context response message or an identification response message, then the message interaction unit accordingly sends a route area update acceptance message or a route area attachment acceptance message to the UE to indicate mapping success of the network-side key identifier; and if the message of sending the key and the key identifier by the MME is a forward and redirect request message, then the message interaction unit sends a forward and redirect response message to the MME to indicate mapping success of the network-side key identifier.

The system for generating a key identity identifier maps a value of a KSI_{ASME} into a value of a KSI or a value of a CKSN, and guarantees that the KSI or CKSN acquired through mapping and a key sequence number previously stored in a SGSN do not repeat, thus solving the problem in the prior art that an IK and a CK or a Kc mapped from the K_{ASME} cannot be reused due to lack of identity identifiers when the UE transfers from an EUTRAN to a UTRAN, and reducing interactive signaling between the UE and the network, and improving user satisfaction.

The following part further describes the invention with six application examples.

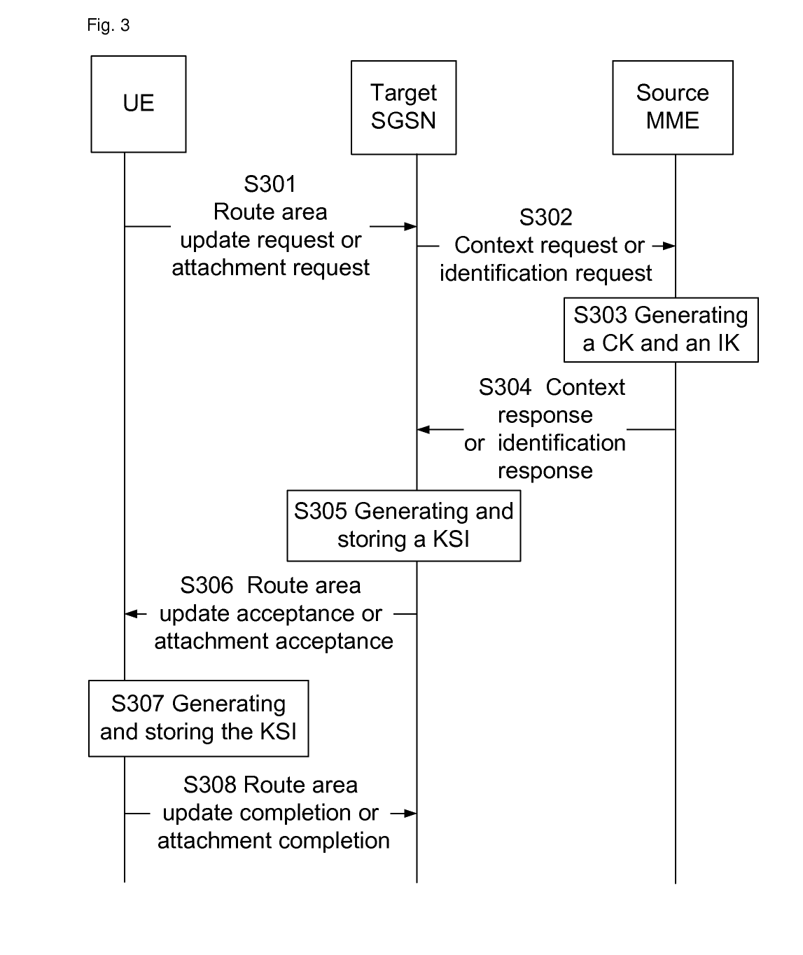

FIG. 3 is Application Example One of the method in the present invention, illustrating a flowchart of the method for generating a key identifier when a UE transfers in an idle state from an EUTRAN to a UTRAN, which includes the following steps:

step S301: a UE decides to transfer to a UTRAN in an idle state and sends a target SGSN a request message of idle transferring to the UTRAN, wherein the request message may be a route area update request message or a route area attachment request message;

step S302: after receiving the request message of idle transferring to the UTRAN sent from the UE, the target SGSN sends a source MME a request message, wherein the type of the request message is corresponding to that of a transfer request message, i.e., it can be a context request message or an identification request message;

step S303: after receiving the request message from the target SGSN, the source MME generates a CK and an IK based on a K_{ASME};

step S304: the source MME correspondingly responds with a context response message or an identification response message, and sends the CK, the IK and a KSI_{ASME} to the target SGSN;

step S305: after receiving the CK, the IK and the KSI_{ASME} from the source MME, the target SGSN assigns the value of the KSI_{ASME} to a KSI, i.e., KSI=KSI_{ASME}, and stores the KSI together with the CK and the IK;

step S306: the target SGSN sends the UE a acceptance message of idle transferring to the UTRAN (correspondingly, a route area update acceptance message or a route area attachment acceptance message) to notify the UE of mapping success of the network-side key identifier;

step S307: the UE assigns the value of the KSI_{ASME} to a KSI, i.e., KSI=KSI_{ASME}, and stores the KSI together with the IK and the CK which are generated from the K_{ASME}; and

step S308: the UE sends a corresponding route area update completion message or route area attachment completion message to the target SGSN.

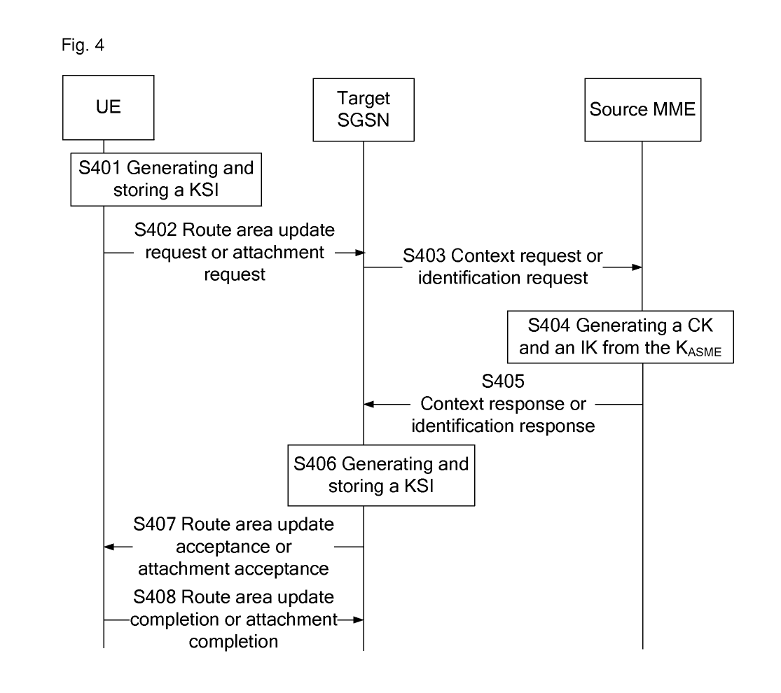

FIG. 4 is Application Example Two of the method in the present invention, illustrating a flowchart of the method for generating a key identifier when a UE transfers in an idle state from an EUTRAN to a UTRAN, which includes the following steps:

step S401: a UE decides to transfer to a UTRAN in an idle state, assigns a value of a KSI_{ASME} to a KSI, i.e., KSI=KSI_{ASME}, and stores the KSI together with an IK and a CK which are generated from a K_{ASME};

step S402: the UE sends a target SGSN a request message of idle transferring to the UTRAN, wherein the request message may be a route area update request message or a route area attachment request message;

step S403: after receiving the request message of idle transferring to the UTRAN sent from the UE, the target SGSN sends a source MME a request message, wherein the type of the request message is corresponding to that of the transfer request message, i.e., it can be a context request message or an identification request message;

step S404: after receiving the request message from the SGSN, the source MME generates a CK and an IK based on the K_{ASME};

step S405: the MME correspondingly responds with a context response message or an identification response message, and sends the CK, the IK and the KSI_{ASME} to the SGSN;

step S406: after receiving the KSI_{ASME}, the CK and the IK from the source MME, the target SGSN assigns the value of the KSI_{ASME} to a KSI, i.e., KSI=KSI_{ASME}, and stores the KSI together with the CK and the IK;

step S407: the target SGSN sends the UE a acceptance message of idle transferring to the UTRAN (correspondingly, a route area update acceptance message or an attachment acceptance message) to notify the UE of mapping success of the network-side key identifier; and

step S408: the UE sends a corresponding route area update completion message or route area attachment completion message to the target SGSN.

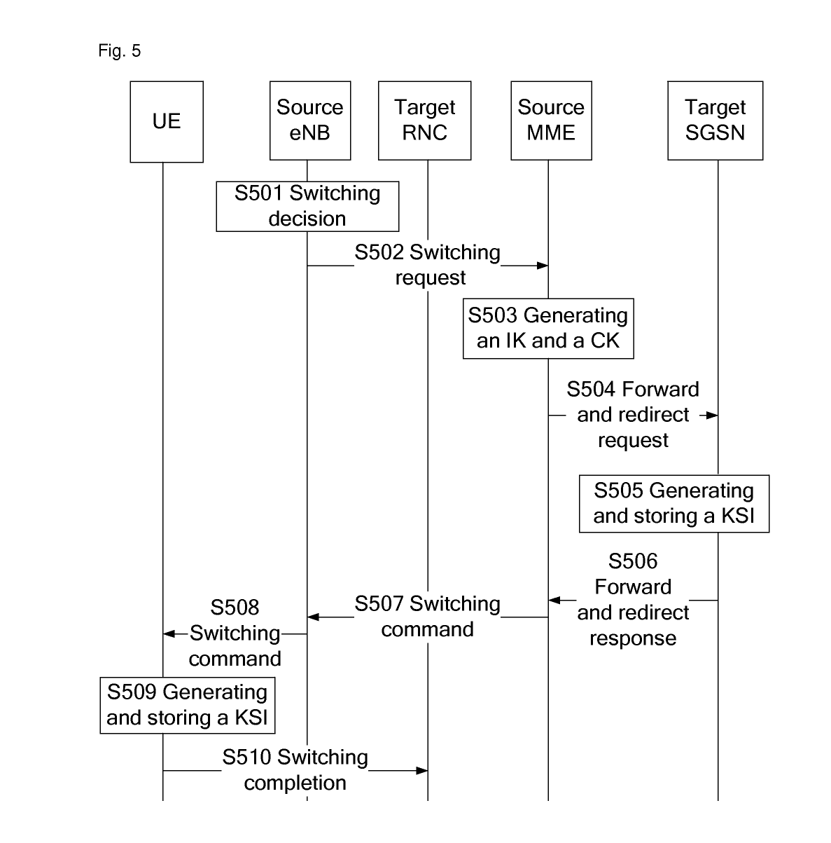

FIG. 5 is Application Example Three of the method in the present invention, illustrating a flowchart of the method for generating a key identifier when a UE switches in an idle state from an EUTRAN to a UTRAN, which includes the following steps:

step S501: a source eNB decides to initiate switching based on either a survey report sent from a UE to the eNB or other reasons;

step S502: the source eNB sends a source MME a switching request message;

step S503: the source MME generates an IK and a CK based on a K_{ASME};

step S504: the source MME sends a target SGSN a forward and redirect request, and transmits a KSI_{ASME} together with the IK and the CK to the target SGSN;

step S505: the target SGSN assigns the value of the KSI_{ASME} to a KSI, i.e., KSI=KSI_{ASME}, and stores the KSI together with the IK and the CK;

step S506: the target SGSN sends the source MME a forward and redirect response message to notify the source MME that the target service network has been prepared for switching;

step S507: the source MME sends the eNB a switching command;

step S508: the source eNB sends the UE an EUTRAN switching command;

step S509: the UE assigns the value of the KSI_{ASME} to a KSI, i.e., KSI=KSI_{ASME}, generates an IK and a CK based on the K_{ASME}, and stores the KSI together with the CK and the IK; and

step S510: the UE sends a switching success message to a target RNC to notify it of mapping success of the network KSI.

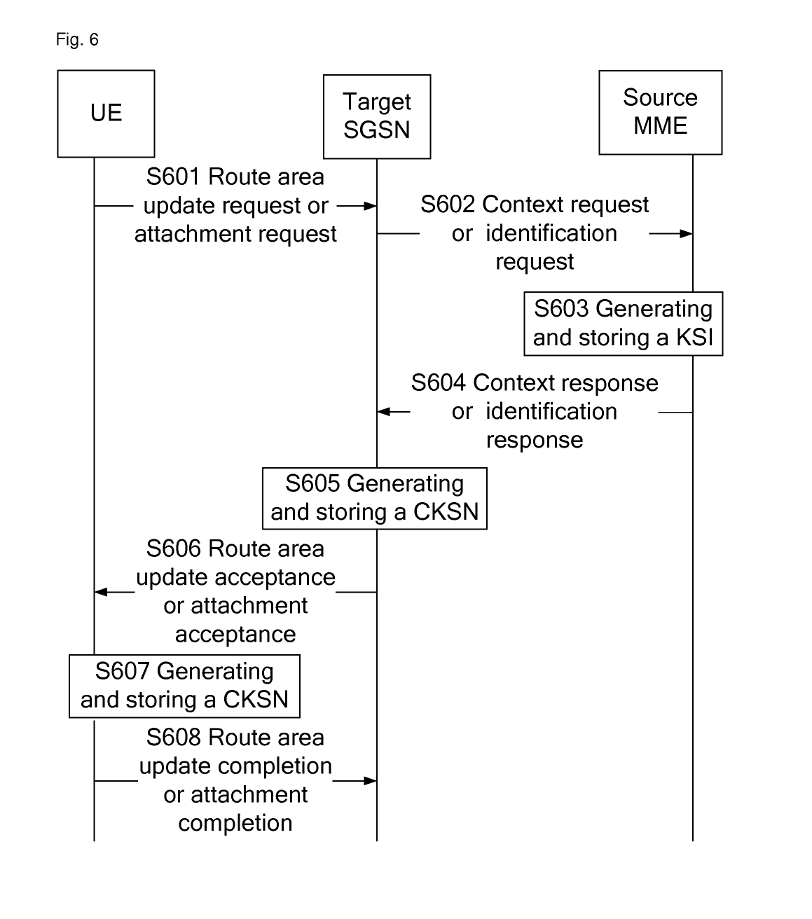

FIG. 6 is Application Example Four of the method in the present invention, illustrating a flowchart of the method for generating a key identifier when a UE transfers in an idle state from an EUTRAN to a GERAN, which includes the following steps:

step S601: a UE decides to transfer to a GERAN in an idle state, and sends a target SGSN a request message of idle transferring to the GERAN, wherein the request message can be a route area update request message or a route area attachment request message;

step S602: after receiving the request message of idle transferring to the GERAN sent from the UE, the target SGSN sends a source MME a request message, wherein the type of the request message is corresponding to that of a received transfer request message, i.e., it can be a context request message or an identification request message;

step S603: after receiving the request message from the target SGSN, the source MME generates a CK and an IK based on a K_{ASME};

step S604: the source MME correspondingly responds with a context response message or an identification response message, and sends the CK, the IK and a KSI_{ASME} to the target SGSN;

step S605: after receiving the KSI_{ASME}, the CK and the IK from the source MME, the target SGSN assigns the value of the KSI_{ASME} to a CKSN, i.e., CKSN=KSI_{ASME}, and stores the CKSN together with a Kc generated from the CK and the IK;

step S606: the target SGSN sends the UE a corresponding acceptance message of idle transferring to the UTRAN (correspondingly, a route area update acceptance message or a route area attachment acceptance message) to notify the UE of mapping success of the network-side key identifier;

step S607: the UE assigns the value of the KSI_{ASME} to a CKSN, i.e., CKSN=KSI_{ASME}, and stores the CKSN together with a Kc generated from the K_{ASME}; and

step S608: the UE sends a corresponding route area update completion message or route area attachment completion message to the target SGSN.

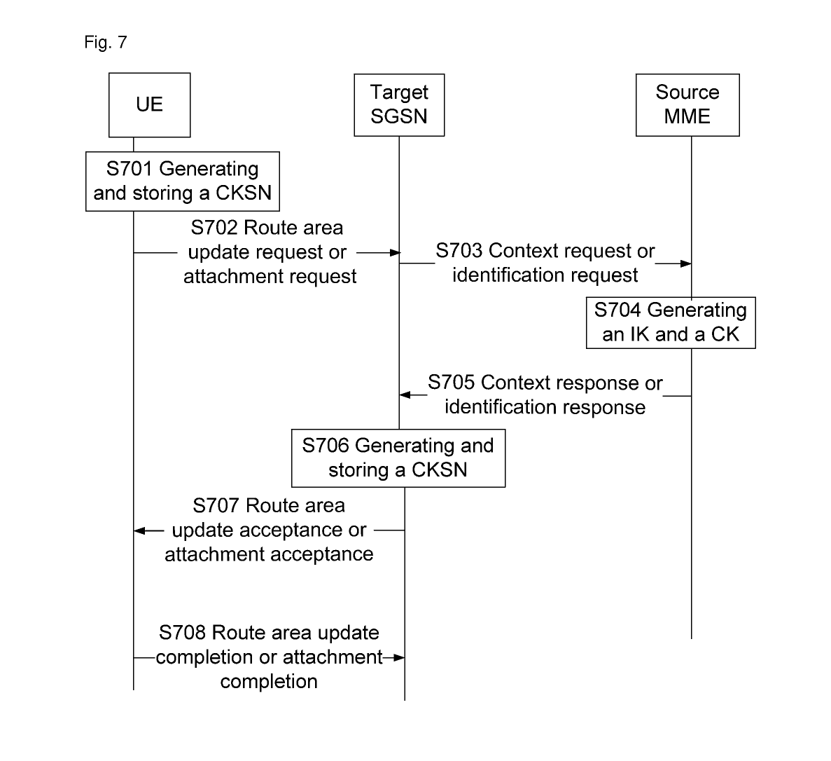

FIG. 7 is Application Example Five of the method in the present invention, illustrating a flowchart of the method for generating a key identifier when a UE transfers in an idle state from an EUTRAN to a GERAN, which includes the following steps:

step S701: a UE decides to transfer to a GERAN in an idle state, assigns a value of a KSI_{ASME} to a CKSN, i.e., CKSN=KSI_{ASME}, and stores the CKSN together with a Kc generated from a K_{ASME};

step S702: the UE sends a target SGSN a request message of idle transferring to the GERAN, wherein the request message can be a route area update request message or a route area attachment request message;

step S703: after receiving the request message of idle transferring to the GERAN sent from the UE, the target SGSN sends a source MME a request message, wherein the type of the request message is corresponding to that of a received transfer request message, i.e., it can be a context request message or an identification request message;

step S704: after receiving the request message from the target SGSN, the source MME generates a CK and an IK based on the K_{ASME};

step S705: the source MME correspondingly responds with a context response message or an identification response message, and sends the CK, the IK and the KSI_{ASME} to the target SGSN;

step S706: after receiving the KSI_{ASME}, the CK and the IK from the source MME, the target SGSN assigns the value of the KSI_{ASME} to a CKSN, i.e., CKSN=KSI_{ASME}, and stores the CKSN together with a Kc generated from the CK and the IK;

step S707: the target SGSN sends the UE a acceptance message of idle transferring to the GERAN (correspondingly, a route area update acceptance message or a route area attachment acceptance message) to notify the UE of mapping success of the network-side key identifier; and

step S708: the UE sends a corresponding route area update completion message or route area attachment completion message to the target SGSN.

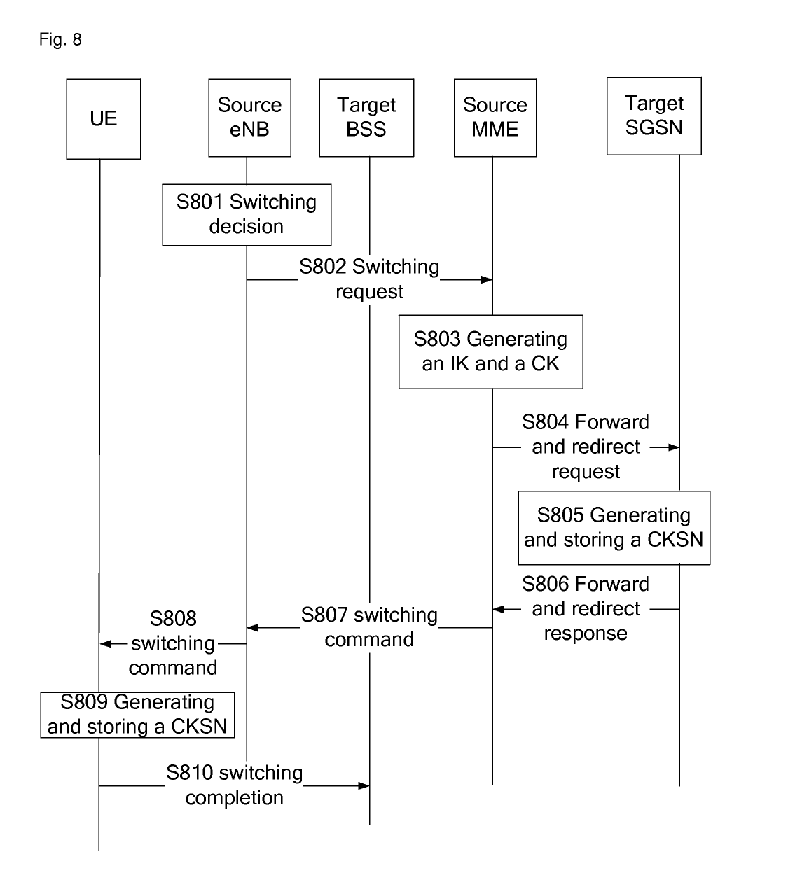

FIG. 8 is Application Example Six of the method in the present invention, illustrating a flowchart of the method for generating a key identifier when a UE switches in an idle state from an EUTRAN to a GERAN, which includes the following steps:

step S801: a source eNB decides to initiate switching based on either a survey report sent from a UE to the eNB or other reasons;

step S802: the source eNB sends a source MME a switching request message;

step S803: the source MME generates an IK and a CK based on a K_{ASME};

step S804: the source MME sends a target SGSN a forward and redirect request, and transmits a KSI_{ASME} together with the IK and the CK to the target SGSN;

step S805: the target SGSN assigns the value of the KSI_{ASME} to a CKSN, i.e., CKSN=KSI_{ASME}, and stores the CKSN together with a Kc generated from the IK and the CK;

step S806: the target SGSN sends the source MME a forward and redirect response message to notify the source MME that the target service network has been prepared for switching;

step S807: the source MME sends the eNB a switching command;

step S808: the source eNB sends the UE an EUTRAN switching command;

step S809: the UE assigns the value of the KSI_{ASME} to a CKSN, i.e., CKSN=KSI_{ASME}, generates a Kc based on the K_{ASME}, and stores the CKSN together with the Kc; and

step S810: the UE sends a switching success message to a target RNC to notify it of mapping success of the network CKSN.

In the above-mentioned six application examples, the UE and the SGSN may also assign the sum of the KSI_{ASME} and a constant to the key identity identifier of the target system; the constant is agreed on by the UE and the network, wherein the sum of the KSI_{ASME} and the constant can not be 111, otherwise, it may be altered according to the agreement between the UE and the SGSN, e.g. by replacing it with a next value 000 or another value.

Obviously, those skilled in the art should understand that various modules or steps of the present invention can be implemented by universal computing devices, they may be integrated in a single computing device, or may be distributed in a network consisting of multiple computing devices; alternatively, they can be implemented by codes executable by computing devices. Therefore, they can be stored in a storage device to be executed by a computing device, or they can be made into various integrated circuit modules, or multiple modules or steps thereof can be made into a single integrated circuit module. Thus, the present invention is not limited to any specific combination of hardware and software.

The above examples are only preferred embodiments of the present invention, and do not constitute limitation to the present invention. For those skilled in the art, the present invention can have a variety of modifications and changes. Any change, equivalent substitute, or improvement, made in the spirit and principles of the invention shall be included within the scope of protection of the present invention.

What is claimed is:

1. A method for generating a key identity identifier when a UE (user equipment) transfers, including the following steps: when a UE transfers from an EUTRAN (evolved UMTS terrestrial radio access network) to a target system, an MME (mobility management entity) of the EUTRAN sending a KSI_{ASME} (an identity identifier of an access security management entity key (K_{ASME})) to an SGSN (serving GPRS support node) of the target system, and both the SGSN and the UE mapping the KSI_{ASME} into a key identity identifier of the target system.

2. The generating method according to claim 1, wherein the mapping method includes the following steps: directly assigning the KSI_{ASME} to the key identity identifier of the target system, or directly assigning the sum of the KSI_{ASME} and a constant that is agreed on by the UE and the network to the key identity identifier of the target system.

3. The generating method according to claim 1, wherein the specific steps are as follows when the UE transfers in an idle state from the EUTRAN to a UTRAN (universal terrestrial radio access network):
A1: after receiving a context request message or an identification request message, the MME generates an IK (integrity key) and a CK (ciphering key) based on the K_{ASME}, and sends the KSI_{ASME} together with the IK and the CK which are generated from the K_{ASME} to the SGSN through a context response message or an identification response message;
A2: after receiving the KSI_{ASME}, the IK and the CK from the MME, the SGSN maps the KSI_{ASME} into a KSI (key set identifier), and stores the KSI, the IK and the CK; and the SGSN sends a message of indicating mapping completion of the KSI to the UE; and
A3: the UE maps the KSI_{ASME} into a KSI, and stores the KSI together with the IK and the CK which are generated from the K_{ASME}.

4. The generating method according to claim 3, wherein step A3 takes place in any step after the UE decides to transfer to the UTRAN in an idle state and before the UE sends a corresponding route area update completion message or route area attachment completion message to the SGSN.

5. The generating method according to claim 1, wherein the specific steps are as follows when the UE switches from the EUTRAN to a UTRAN:
a1: after receiving a switching request message, the MME generates an IK and a CK based on the K_{ASME}, and sends the KSI_{ASME} together with the IK and the CK which are generated from the K_{ASME} to the SGSN through a forward and redirect request message;
a2: after receiving the KSI_{ASME} together with the IK and the CK from the MME, the SGSN maps the KSI_{ASME} into a KSI, and stores the KSI, the IK and the CK together; the SGSN sends a forward and redirect response message of indicating mapping completion of the KSI to the MME; and the MME sends a switching command to instruct the UE to switch; and
a3: after receiving the switching command from the network, the UE maps the KSI_{ASME} into a KSI, and stores the KSI together with the IK and the CK which are generated from the K_{ASME}.

6. The generating method according to claim 1, wherein the specific steps are as follows when the UE transfers in an idle state from the EUTRAN to a GERAN (general packet radio service (GPRS)/enhanced data rates for global evolution (EDGE) radio access network):
B1: after receiving a context request message or an identification request message, the MME generates an IK and a CK based on the K_{ASME}, and sends the KSI_{ASME} together with the IK and the CK which are generated from the K_{ASME} to the SGSN through a context response message or an identification response message;
B2: after receiving the KSI_{ASME}, the IK and the CK from the MME, the SGSN generates a Kc (ciphering key) of the GERAN based on the IK and the CK, maps the KSI_{ASME} into a CKSN (ciphering key sequence number) of the GERAN, and stores the CKSN of the GERAN together with the Kc of the GERAN; and the SGSN sends the UE a message of indicating mapping completion of the CKSN of the GERAN; and
B3: the UE maps the KSI_{ASME} into a CKSN of the GERAN, and stores the CKSN of the GERAN together with the Kc of the GERAN generated from the K_{ASME}.

7. The generating method according to claim 6, wherein step B3 takes place in any step after the UE decides to transfer to the GERAN in an idle state and before the UE sends a switching message to the network.

8. The generating method according to claim 1, wherein the specific steps are as follows when the UE switches from the EUTRAN to a GERAN:
b1: after receiving a switching request message, the MME generates an IK and a CK based on the K_{ASME}, and sends the KSI_{ASME} together with the IK and the CK which are generated from the K_{ASME} to the SGSN through a forward and redirect request message;
b2: after receiving the KSI_{ASME} together with the IK and the CK from the MME, the SGSN generates a Kc of the GERAN based on the IK and the CK, assigns the value of the KSI_{ASME} to a CKSN of the GERAN, and stores the CKSN of the GERAN together with the Kc of the GERAN; the SGSN sends a message of indicating mapping completion of the CKSN of the GERAN to the MME; and the MME sends a switching command to instruct the UE to switch; and
b3: after receiving the switching command from the network, the UE maps the KSI_{ASME} into a CKSN of the GERAN, and stores the CKSN of the GERAN together with the Kc of the GERAN generated from the K_{ASME}.

9. A system for generating a key identity identifier when a UE transfers, including a UE (user equipment), an MME (mobility management entity) and an SGSN (serving GPRS support node):
the MME being used for sending a KSI_{ASME} (an identity identifier of an access security management entity key (K_{ASME})) to the SGSN when the UE transfers from an EUTRAN (evolved UMTS terrestrial radio access network) to a target system; and
both the SGSN and the UE being used for mapping the KSI_{ASME} into a key identity identifier of the target system.

10. The generating system according to claim 9, wherein the SGSN/UE performs mapping in the following method: directly assigning the KSI_{ASME} to the key identity identifier of the target system, or directly assigning the sum of the KSI_{ASME} and a constant that is agreed on by the UE and the network to the key identity identifier of the target system.

11. The generating system according to claim 9, wherein the UE and the SGSN are also used for deleting a key stored before transferring when the UE and the SGSN have agreed on a key before transferring and a key identity identifier of a target system is the same as the key identity identifier of the target system converted from the KSI_{ASME} during transferring.

12. The generating system according to claim 9, wherein
the UE consists of a message interaction unit, a key identifier mapping unit and a key and key identifier storage unit;
the message interaction unit is used for receiving a message from a network side;
the key identifier mapping unit is used for mapping the KSI_{ASME} into a key identity identifier of a target system when the message interaction unit receives a switching command, a route area update acceptance message or a route area attachment acceptance message; and
the key and key identifier storage unit is used for storing a key of a target system and a key identity identifier of the target system together;
the MME consists of a request message receiving unit and a security parameter processing unit;
the request message receiving unit is used for receiving transfer request messages from other network entities and instructing the security parameter processing unit to process these messages; and
the security parameter processing unit is used for generating a CK and an IK from the K_{ASME} and sending the KSI_{ASME} together with the IK and the CK which are generated from the K_{ASME} to the SGSN after receiving the instruction from the request message receiving unit;
the SGSN consists of a security parameter receiving unit, a message interaction unit, a key identifier mapping unit, and a key and key identifier storage unit;
the security parameter receiving unit is used for receiving the keys and the KSI_{ASME} from the MME, sending the KSI_{ASME} to the key identifier mapping unit, acquiring the key of the target system based on the keys sent by the MME, and sending it to the key and key identifier storage unit;
the key identifier mapping unit is used for mapping the KSI_{ASME} into a key identity identifier of the target system after receiving the KSI_{ASME};
the key and key identifier storage unit is used for storing both the key of the target system sent by the security parameter receiving unit and the key identity identifier of the target system sent by the key identifier mapping unit, and notifying the message interaction unit of mapping completion after storing; and
the message interaction unit is used for sending a notification of mapping success of the network-side key identifier after receiving the message of mapping completion.

13. The generating system according to claim 12, wherein
the key identifier mapping units in the UE and the SGSN map the KSI_{ASME} into a key identity identifier of the target system, i.e. when the target system is a UTRAN, the KSI_{ASME} is mapped into a KSI; and when the target system is a GERAN, the KSI_{ASME} is mapped into a CKSN of the GERAN; and
the security parameter receiving unit in the SGSN acquires the key of the target system based on the keys sent by the MME and sends it to the key and key identifier storage unit, i.e. when the target system is a UTRAN, the keys sent by the MME are sent to the key and key identifier storage unit; and when the target system is a GERAN, the keys sent by the MME are used to generate a Kc of the GERAN which is sent to the key and key identifier storage unit.

14. The generating system according to claim 12, wherein the key identifier mapping unit in the UE is also used for mapping the KSI_{ASME} into the key identity identifier of the target system when the UE decides to transfer in an idle state.

15. The generating system according to claim 12, wherein
the message interaction unit in the UE is also used for sending a route area update request message or a route area attachment request message to the SGSN when the UE decides to transfer in an idle state;
the message interaction unit in the SGSN is also used for sending a corresponding context request message or identification request message to the MME after receiving the route area update request message or the route area attachment request message;
the request message receiving unit in the MME sends a first processing instruction to the security parameter processing unit if the transfer request message is a context request message or an identification request message, and the request message receiving unit sends a second processing instruction to the security parameter processing unit if the transfer request message is a switching request message; and
the security parameter processing unit in the MME sends the KSI_{ASME} together with the IK and the CK which are generated from the K_{ASME} to the SGSN through a context response message or an identification response message after receiving the first processing instruction, and the security parameter processing unit sends the KSI_{ASME} together with the IK and the CK which are generated from the K_{ASME} to the SGSN through a forward and redirect request message after receiving the second processing instruction.

16. The generating system according to claim 15, wherein the message interaction unit in the SGSN sends a notification of mapping success of the network-side key identifier, i.e.: if the message of sending the key and the key identifier by the MME is a context response message or an identification response message, then the message interaction unit sends a route area update acceptance message or a route area attachment acceptance message to the UE to indicate mapping success of the network-side key identifier; and if the message of sending the key and the key identifier by the MME is a forward and redirect request message, then the message interaction unit sends a forward and redirect response message to the MME to indicate mapping success of the network-side key identifier.

17. The generating method according to claim 2, wherein the specific steps are as follows when the UE transfers in an idle state from the EUTRAN to a UTRAN:
A1: after receiving a context request message or an identification request message, the MME generates an IK and a CK based on the K_{ASME}, and sends the KSI_{ASME} together with the IK and the CK which are generated from the K_{ASME} to the SGSN through a context response message or an identification response message;
A2: after receiving the KSI_{ASME}, the IK and the CK from the MME, the SGSN maps the KSI_{ASME} into a KSI, and stores the KSI, the IK and the CK; and the SGSN sends a message of indicating mapping completion of the KSI to the UE; and
A3: the UE maps the KSI_{ASME} into a KSI, and stores the KSI together with the IK and the CK which are generated from the K_{ASME}.

18. The generating method according to claim 17, wherein step A3 takes place in any step after the UE decides to transfer to the UTRAN in an idle state and before the UE sends a corresponding route area update completion message or route area attachment completion message to the SGSN.

19. The generating method according to claim 2, wherein the specific steps are as follows when the UE switches from the EUTRAN to a UTRAN:
a1: after receiving a switching request message, the MME generates an IK and a CK based on the K_{ASME}, and sends the KSI_{ASME} together with the IK and the CK which are generated from the K_{ASME} to the SGSN through a forward and redirect request message;
a2: after receiving the KSI_{ASME} together with the IK and the CK from the MME, the SGSN maps the KSI_{ASME} into a KSI, and stores the KSI, the IK and the CK together; the SGSN sends a forward and redirect response message of indicating mapping completion of the KSI to the MME; and the MME sends a switching command to instruct the UE to switch; and
a3: after receiving the switching command from the network, the UE maps the KSI_{ASME} into a KSI, and stores the KSI together with the IK and the CK which are generated from the K_{ASME}.

20. The generating method according to claim 2, wherein the specific steps are as follows when the UE transfers in an idle state from the EUTRAN to a GERAN:
B1: after receiving a context request message or an identification request message, the MME generates an IK and a CK based on the K_{ASME}, and sends the KSI_{ASME} together with the IK and the CK which are generated from the K_{ASME} to the SGSN through a context response message or an identification response message;
B2: after receiving the KSI_{ASME}, the IK and the CK from the MME, the SGSN generates a Kc of the GERAN based on the IK and the CK, maps the KSI_{ASME} into a CKSN of the GERAN, and stores the CKSN of the GERAN together with the Kc of the GERAN; and the SGSN sends the UE a message of indicating mapping completion of the CKSN of the GERAN; and
B3: the UE maps the KSI_{ASME} into a CKSN of the GERAN, and stores the CKSN of the GERAN together with the Kc of the GERAN generated from the K_{ASME}.

21. The generating method according to claim 20, wherein step B3 takes place in any step after the UE decides to transfer to the GERAN in an idle state and before the UE sends a switching message to the network.

22. The generating method according to claim 2, wherein the specific steps are as follows when the UE switches from the EUTRAN to a GERAN:
b1: after receiving a switching request message, the MME generates an IK and a CK based on the K_{ASME}, and sends the KSI_{ASME} together with the IK and the CK which are generated from the K_{ASME} to the SGSN through a forward and redirect request message;
b2: after receiving the KSI_{ASME} together with the IK and the CK from the MME, the SGSN generates a Kc of the GERAN based on the IK and the CK, assigns the value of the KSI_{ASME} to a CKSN of the GERAN, and stores the CKSN of the GERAN together with the Kc of the GERAN; the SGSN sends a message of indicating mapping completion of the CKSN of the GERAN to the MME; and the MME sends a switching command to instruct the UE to switch; and
b3: after receiving the switching command from the network, the UE maps the KSI_{ASME} into a CKSN of the GERAN, and stores the CKSN of the GERAN together with the Kc of the GERAN generated from the K_{ASME}.

23. The generating system according to claim 10, wherein
the UE consists of a message interaction unit, a key identifier mapping unit and a key and key identifier storage unit;
the message interaction unit is used for receiving a message from a network side;
the key identifier mapping unit is used for mapping the KSI_{ASME} into a key identity identifier of a target system when the message interaction unit receives a switching command, a route area update acceptance message or a route area attachment acceptance message; and
the key and key identifier storage unit is used for storing a key of a target system and a key identity identifier of the target system together;
the MME consists of a request message receiving unit and a security parameter processing unit;
the request message receiving unit is used for receiving transfer request messages from other network entities and instructing the security parameter processing unit to process these messages; and
the security parameter processing unit is used for generating a CK and an IK from the K_{ASME} and sending the KSI_{ASME} together with the IK and the CK which are generated from the K_{ASME} to the SGSN after receiving the instruction from the request message receiving unit;
the SGSN consists of a security parameter receiving unit, a message interaction unit, a key identifier mapping unit, and a key and key identifier storage unit;
the security parameter receiving unit is used for receiving the keys and the KSI_{ASME} from the MME, sending the KSI_{ASME} to the key identifier mapping unit, acquiring the key of the target system based on the keys sent by the MME, and sending it to the key and key identifier storage unit;
the key identifier mapping unit is used for mapping the KSI_{ASME} into a key identity identifier of the target system after receiving the KSI_{ASME};
the key and key identifier storage unit is used for storing both the key of the target system sent by the security parameter receiving unit and the key identity identifier of the target system sent by the key identifier mapping unit, and notifying the message interaction unit of mapping completion after storing; and
the message interaction unit is used for sending a notification of mapping success of the network-side key identifier after receiving the message of mapping completion.

24. The generating system according to claim 11, wherein
the UE consists of a message interaction unit, a key identifier mapping unit and a key and key identifier storage unit;
the message interaction unit is used for receiving a message from a network side;
the key identifier mapping unit is used for mapping the KSI_{ASME} into a key identity identifier of a target system when the message interaction unit receives a switching command, a route area update acceptance message or a route area attachment acceptance message; and
the key and key identifier storage unit is used for storing a key of a target system and a key identity identifier of the target system together;
the MME consists of a request message receiving unit and a security parameter processing unit;
the request message receiving unit is used for receiving transfer request messages from other network entities and instructing the security parameter processing unit to process these messages; and
the security parameter processing unit is used for generating a CK and an IK from the K_{ASME} and sending the KSI_{ASME} together with the IK and the CK which are generated from the K_{ASME} to the SGSN after receiving the instruction from the request message receiving unit;
the SGSN consists of a security parameter receiving unit, a message interaction unit, a key identifier mapping unit, and a key and key identifier storage unit;
the security parameter receiving unit is used for receiving the keys and the KSI_{ASME} from the MME, sending the KSI_{ASME} to the key identifier mapping unit, acquiring the key of the target system based on the keys sent by the MME, and sending it to the key and key identifier storage unit;
the key identifier mapping unit is used for mapping the KSI_{ASME} into a key identity identifier of the target system after receiving the KSI_{ASME};
the key and key identifier storage unit is used for storing both the key of the target system sent by the security parameter receiving unit and the key identity identifier of the target system sent by the key identifier mapping unit, and notifying the message interaction unit of mapping completion after storing; and
the message interaction unit is used for sending a notification of mapping success of the network-side key identifier after receiving the message of mapping completion.

25. The generating system according to claim 23, wherein
the key identifier mapping units in the UE and the SGSN map the KSI_{ASME} into a key identity identifier of the target system, i.e. when the target system is a UTRAN, the KSI_{ASME} is mapped into a KSI; and when the target system is a GERAN, the KSI_{ASME} is mapped into a CKSN of the GERAN; and
the security parameter receiving unit in the SGSN acquires the key of the target system based on the keys sent by the MME and sends it to the key and key identifier storage unit, i.e. when the target system is a UTRAN, the keys sent by the MME are sent to the key and key identifier storage unit; and when the target system is a GERAN, the keys sent by the MME are used to generate a Kc of the GERAN which is sent to the key and key identifier storage unit.

26. The generating system according to claim 24, wherein
the key identifier mapping units in the UE and the SGSN map the KSI_{ASME} into a key identity identifier of the target system, i.e. when the target system is a UTRAN, the KSI_{ASME} is mapped into a KSI; and when the target system is a GERAN, the KSI_{ASME} is mapped into a CKSN of the GERAN; and
the security parameter receiving unit in the SGSN acquires the key of the target system based on the keys sent by the MME and sends it to the key and key identifier storage unit, i.e. when the target system is a UTRAN, the keys sent by the MME are sent to the key and key identifier storage unit; and when the target system is a GERAN, the keys sent by the MME are used to generate a Kc of the GERAN which is sent to the key and key identifier storage unit.

27. The generating system according to claim 23, wherein the key identifier mapping unit in the UE is also used for mapping the KSI_{ASME} into the key identity identifier of the target system when the UE decides to transfer in an idle state.

28. The generating system according to claim 24, wherein the key identifier mapping unit in the UE is also used for mapping the KSI_{ASME} into the key identity identifier of the target system when the UE decides to transfer in an idle state.

29. The generating system according to claim 23, wherein
the message interaction unit in the UE is also used for sending a route area update request message or a route area attachment request message to the SGSN when the UE decides to transfer in an idle state;
the message interaction unit in the SGSN is also used for sending a corresponding context request message or identification request message to the MME after receiving the route area update request message or the route area attachment request message;
the request message receiving unit in the MME sends a first processing instruction to the security parameter processing unit if the transfer request message is a context request message or an identification request message, and the request message receiving unit sends a second processing instruction to the security parameter processing unit if the transfer request message is a switching request message; and
the security parameter processing unit in the MME sends the KSI_{ASME} together with the IK and the CK which are generated from the K_{ASME} to the SGSN through a context response message or an identification response message after receiving the first processing instruction, and the security parameter processing unit sends the KSI_{ASME} together with the IK and the CK which are generated from the K_{ASME} to the SGSN through a forward and redirect request message after receiving the second processing instruction.

30. The generating system according to claim 24, wherein
the message interaction unit in the UE is also used for sending a route area update request message or a route area attachment request message to the SGSN when the UE decides to transfer in an idle state;
the message interaction unit in the SGSN is also used for sending a corresponding context request message or identification request message to the MME after receiving the route area update request message or the route area attachment request message;
the request message receiving unit in the MME sends a first processing instruction to the security parameter processing unit if the transfer request message is a context request message or an identification request message, and the request message receiving unit sends a second processing instruction to the security parameter processing unit if the transfer request message is a switching request message; and
the security parameter processing unit in the MME sends the KSI_{ASME} together with the IK and the CK which are generated from the K_{ASME} to the SGSN through a context response message or an identification response message after receiving the first processing instruction, and the security parameter processing unit sends the KSI_{ASME} together with the IK and the CK which are generated from the K_{ASME} to the SGSN through a forward and redirect request message after receiving the second processing instruction.

31. The generating system according to claim 29, wherein the message interaction unit in the SGSN sends a notification of mapping success of the network-side key identifier, i.e.: if the message of sending the key and the key identifier by the MME is a context response message or an identification response message, then the message interaction unit sends a route area update acceptance message or a route area attachment acceptance message to the UE to indicate mapping success of the network-side key identifier; and if the message of sending the key and the key identifier by the MME is a forward and redirect request message, then the message interaction unit sends a forward and redirect response message to the MME to indicate mapping success of the network-side key identifier.

32. The generating system according to claim 30, wherein the message interaction unit in the SGSN sends a notification of mapping success of the network-side key identifier, i.e.: if the message of sending the key and the key identifier by the MME is a context response message or an identification response message, then the message interaction unit sends a route area update acceptance message or a route area attachment acceptance message to the UE to indicate mapping success of the network-side key identifier; and if the message of sending the key and the key identifier by the MME is a forward and redirect request message, then the message interaction unit sends a forward and redirect response message to the MME to indicate mapping success of the network-side key identifier.
